(19) United States
(12) Patent Application Publication
(10) Pub. No.: US 2024/0078496 A1
(43) Pub. Date: Mar. 7, 2024

(54) SYSTEMS AND METHODS FOR DERIVING WORKFORCE ACTIVITY AND BEHAVIORAL INSIGHTS FROM DATA EXHAUST

(71) Applicant: JPMORGAN CHASE BANK, N.A., New York, NY (US)

(72) Inventors: Luke STORRIE, Christchurch (GB); Frank VAN HOOF, Ringwood (GB); Zoe BERRY, Upminster (GB); Erik RITSEMA, Dorchester (GB); Meenakshi CHOUDHARY, Jersey City, NJ (US); Tom MARTIN, Lewis Center, OH (US); Jonathan M. BAUM, Brooklyn, NY (US)

(21) Appl. No.: 17/930,386

(22) Filed: Sep. 7, 2022

(51) Int. Cl. G06Q 10/06; G06Q 10/10

(52) U.S. Cl. CPC G06Q 10/06398; G06Q 10/063114; G06Q 10/1091

(57) ABSTRACT

Systems and methods for deriving workforce activity and behavioral insights from data exhaust are disclosed. In one embodiment, a method for deriving workforce activity and behavioral insights from data exhaust may include: (1) ingesting, by a workforce activity data computer program executed by an electronic device, worker data for a plurality of workers from a plurality of data sources; (2) retrieving, by the workforce activity data computer program, reference data; (3) joining, by the workforce activity data computer program, the worker data and the reference data; (4) enriching, by the workforce activity data computer program, derived data points from the joined worker data and reference data; and (5) outputting, by the workforce activity data computer program, the enriched derived data points.

### BACKGROUND OF THE INVENTION

### 1. Field of the Invention

Embodiments generally relate to systems and methods for deriving workforce activity and behavioral insights from data exhaust.

### 2. Description of the Related Art

Institutions capture data from different systems. From access control systems to computer networks, to scheduling systems, this data is usually used to assist with helping workers or teams access the resources they need to in order to complete their jobs.

### SUMMARY OF THE INVENTION

Systems and methods for deriving workforce activity and behavioral insights from data exhaust are disclosed. In one embodiment, a method for deriving workforce activity and behavioral insights from data exhaust may include: (1) ingesting, by a workforce activity data computer program executed by an electronic device, worker data for a plurality of workers from a plurality of data sources; (2) retrieving, by the workforce activity data computer program, reference data; (3) joining, by the workforce activity data computer program, the worker data and the reference data; (4) enriching, by the workforce activity data computer program, derived data points from the joined worker data and reference data; and (5) outputting, by the workforce activity data computer program, the enriched derived data points.

In one embodiment, the worker data may include worker application usage data, worker facility access data, worker network access data, worker calendar data, and worker email data.

In one embodiment, the reference data may include employee data and real estate data.

In one embodiment, the worker data and the reference data may be joined using linked identifiers.

In one embodiment, the method may also include de-identifying, by the workforce activity data computer program, the worker data.

In one embodiment, the enriched derived data points may include a range for one of the plurality of workers, a digital footprint for one of plurality of workers, a combined activity metric footprint for one of plurality of workers, a time spent in office metric for one of plurality of workers, a time spent remote for one of plurality of workers, a time spent in in-person meetings metric for one of plurality of workers, a time spent in virtual meetings metric for one of plurality of workers, a time spent on phone metric for one of plurality of workers, and/or a time spent in one-on-one meeting with managers or subordinates metric.

In one embodiment, the enriched derived data points may be output at a worker level, a team level, an office level, and/or an organization level.

In one embodiment, the method may also include interfacing, by the workforce activity data computer program, with a calendaring program to limit meeting time for one of the plurality of workers based on one of the enriched derived data points.

In one embodiment, the method may also include interfacing, by the workforce activity data computer program, with a phone system to route incoming phone calls for one of the plurality of workers to voicemail based on one of the enriched derived data points.

In one embodiment, the method may also include interfacing, by the workforce activity data computer program, with a scheduling system to schedule a workspace for one of the plurality of workers based on one of the enriched derived data points.

According to another embodiment, a system may include a plurality of data sources for worker data, and an electronic device executing a workforce activity data computer program. The workforce activity data computer program may ingest worker data for a plurality of workers from a plurality of data sources, receive reference data, join the worker data and the reference data, enrich derived data points from the joined worker data and reference data, and output the enriched derived data points.

In one embodiment, the worker data may include worker application usage data, worker facility access data, worker network access data, worker calendar data, and worker email data.

In one embodiment, the reference data may include employee data and real estate data.

In one embodiment, the worker data and the reference data may be joined using linked identifiers.

In one embodiment, the workforce activity data computer program may de-identify the worker data.

In one embodiment, the enriched derived data points may include a range for one of the plurality of workers, a digital footprint for one of plurality of workers, a combined activity metric footprint for one of plurality of workers, a time spent in office metric for one of plurality of workers, a time spent remote for one of plurality of workers, a time spent in in-person meetings metric for one of plurality of workers, a time spent in virtual meetings metric for one of plurality of workers, a time spent on phone metric for one of plurality of workers, and/or a time spent in one-on-one meeting with managers or subordinates metric.

In one embodiment, the enriched derived data points may be output at a worker level, a team level, an office level, and/or an organization level.

In one embodiment, the workforce activity data computer program may interface with a calendaring program to limit meeting time for one of the plurality of workers based on one of the enriched derived data points.

In one embodiment, the workforce activity data computer program may interface with a phone system to route incoming phone calls for one of the plurality of workers to voicemail based on one of the enriched derived data points.

In one embodiment, the workforce activity data computer program may interface with a scheduling system to schedule a workspace for one of the plurality of workers based on one of the enriched derived data points.

### BRIEF DESCRIPTION OF THE DRAWINGS

In order to facilitate a fuller understanding of the present invention, reference is now made to the attached drawings in which:

FIG. 1 discloses a system for deriving workforce activity and behavioral insights from data exhaust according to one embodiment;

FIG. 2 depicts a method for deriving workforce activity and behavioral insights from data exhaust according to one embodiment;

FIG. 3 depicts an exemplary dashboard according to an embodiment; and

FIG. 4 depicts an exemplary computing system for implementing aspects of the present disclosure.

### DETAILED DESCRIPTION OF PREFERRED EMBODIMENTS

Systems and methods for deriving workforce activity and behavioral insights from data exhaust are disclosed.

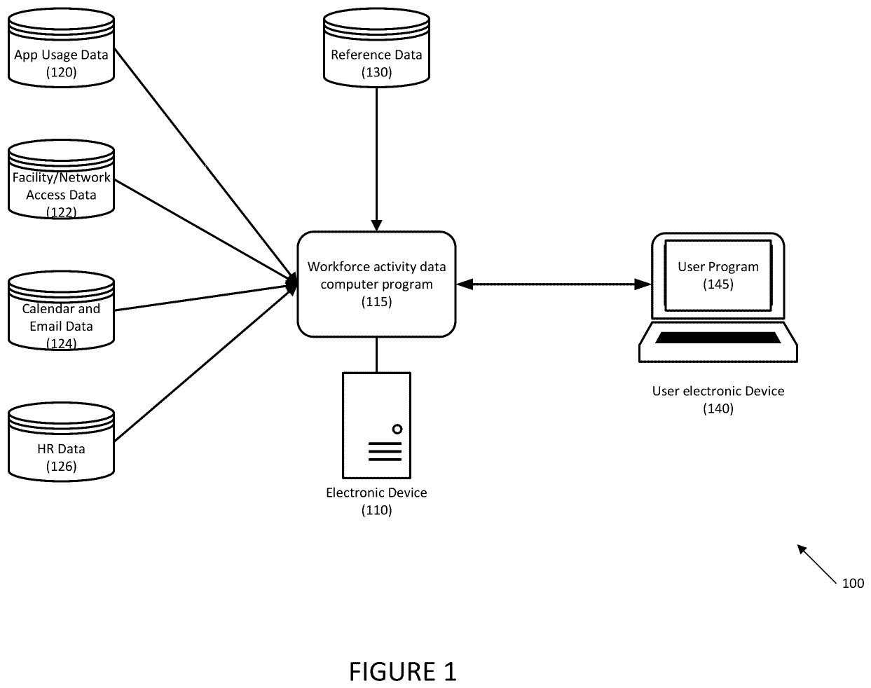

Referring to FIG. 1, a system for deriving workforce activity and behavioral insights from data exhaust is disclosed according to one embodiment. System 100 may include electronic device 110, which may be any suitable electronic device including servers (e.g., cloud-based and/or physical), workstations, computers (e.g., desktop, laptop, notebook, etc.), etc. An example of electronic device 110 is computing device 300, described below.

Electronic device 110 may execute workforce activity data computer program 115. Workforce activity data computer program 115 may receive data from one or more sources of worker data, including, for example data sources that provide worker data regarding application usage data 120, facility and network access data 122 (e.g., badge swipes, secure authentication token use, etc.), calendar and email data 124, human resources (HR) data 126, etc. These sources of worker data may be databases, systems, etc. and may provide streaming data, past data, etc. In one embodiment, the data provided by these sources of data may be raw data received in a format used by the source of data.

Although the term “worker” may be used herein, it should be recognized that this may include a single worker, multiple workers, a team of worker, etc.

Workforce activity data computer program 115 may further communicate with source of reference data 130, including employee data (e.g., line of business, manager, position, etc.), real estate data (e.g., business location, seat assignment, etc.), etc. Although reference data 130 may change periodically, it is predominantly static data.

Workforce activity data computer program 115 may process the worker data and the reference data. For example, workforce activity data computer program 115 may join the worker data (e.g., app usage data 120, facility access data 122, calendar and email data 124, HR data 126) with reference data 130.

After joining the data, workforce activity data computer program 115 may execute logic that may perform calculations on the joined worker data and reference data, and may identify and enrich new derived data points from the data. For example, workforce activity data computer program 115 may calculate a worker range—the amount of time a worker spends at work during a workday. The range calculation may include data from facility and network access data 122 (e.g., secure authentication token use, badge swipe data), app usage data 120 (e.g., workstation access data, calls data), etc. Workforce activity data computer program 115 may then evaluate the start end times of these activities to calculate a range for each worker.

As another example, workforce activity data computer program 115 may calculate a digital footprint for each worker. A digital footprint may indicate whether or not a worker was present on a given day. This calculation may include data from facility and network access data 122 (e.g., secure authentication token use, badge swipe data), app usage data 120 (e.g., workstation access data, calls data), etc. Workforce activity data computer program 115 may then evaluate these activities to calculate a range for each worker.

As another example, workforce activity data computer program 115 may calculate a combined activity for each worker. The combined activity gives a view into a worker's total activity throughout the day by overlapping, for example, from facility and network access data 122 (e.g., secure authentication token use, badge swipe data), app usage data 120 (e.g., workstation access data, calls data), calendar and email data 124 (e.g., meetings), etc. Prior to this metric, a worker who was in a meeting, on a zoom call, and on their computer for a 30-minute period would be determined to have an hour and a half of activity. By calculating the overlap in this data and deriving this new data point, workforce activity data computer program 115 may present those 30 minutes as being spent multi-tasking, and therefore more accurately indicates total activity.

Workforce activity data computer program 115 may interface with user program 145 that may be executed by user electronic device 140. User electronic device may be any suitable electronic device, including smartphones, computers (e.g., workstations, desktops, laptops, notebooks, tablets, etc.), Internet of Things (IoT) appliances, terminals, etc. User electronic device 140 may also be computing device 400, described below.

Workforce activity data computer program 115 may output the derived data points, for example by visualization. The visualizations may include both existing data points, and new derived data points. For example, workforce activity data computer program 115 may visualize a workforce's activity (e.g., digital footprint, range, combined activity, etc.), calls (e.g., call counts, call duration, scheduled versus unscheduled calls, etc.), meetings (e.g., meeting counts, meeting duration, attendee count, attendee participation, etc.), real estate (e.g., desk usage, space usage, allocation, etc.), etc. Other visualizations may be provided as is necessary and/or desired.

In one embodiment, the digital footprints may be used to assist with finding a workspace or desk for a worker. This may, for example, based on historical preferences.

Embodiments may also improve resiliency of computing and related systems. For example, embodiments may use historical events to minimize the impact of outages.

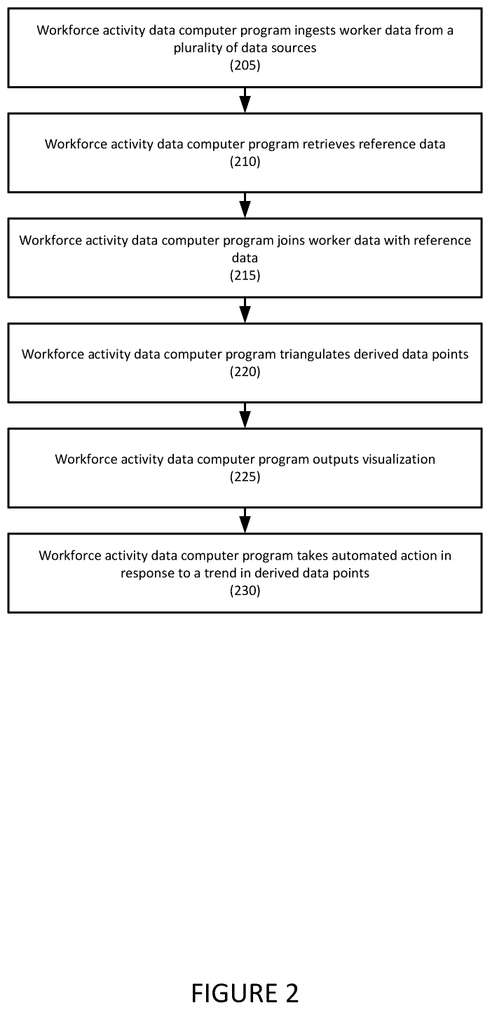

Referring to FIG. 2, a method for deriving workforce activity and behavioral insights from data exhaust is disclosed according to an embodiment.

In step 205, a workforce activity data computer program executed by an electronic device may ingest worker data from a plurality of data sources. For example, the workforce activity data computer program may ingest worker data such as worker application usage data, facility and network access data 122 (e.g., badge swipes, secure authentication token use, etc.), calendar and email data 124, human resources (HR) data 126, etc. These sources of worker data may be databases, systems, etc. and may provide streaming data, past data, etc. In one embodiment, the data provided by these sources of data may be raw data received in a format used by the source of data.

In step 210, the workforce activity data computer program may retrieve reference data, such as employee data (e.g., line of business, manager, position, etc.), real estate data (e.g., business location, seat assignment, etc.), etc. In one embodiment, the reference data may be substantially static data.

In step 215, the workforce activity data computer program may join the worker data with the reference data. For example, using linked identifiers or similar, the worker data may be linked to reference data (e.g., matching a badge identifier for an access card to an employee identifier). In another embodiment, the worker data may be linked to reference data based on timing (e.g., time of arrival at building and time of login to network).

In one embodiment, the reference data and/or the worker data may be de-identified so the reference data cannot be associated with a particular individual. In one embodiment, the de-identification may be the result of the aggregation of worker data from a plurality of workers.

In step 220, the workforce activity data computer program may enrich derived data points from the joined data. For example, the workforce activity data computer program may calculate a range for each worker, a digital footprint for each worker, a combined activity metric for each worker, time spent in the office, time spent remote, time spent in in-person meetings, time spent in virtual meetings, time spent on the phone, time spend in one-on-one meeting with managers or subordinates, etc.

In one embodiment, using the enriched data, the workforce activity data computer program may identify behavioral trends with workers, such as workers that work after midnight workers that are on high-intensity teams, etc.

In step 225, the workforce activity data computer program may output the derived data points. For example, the workforce activity data computer program may output a visualization that may be provided in a dashboard. The visualization may be presented at any desired level, including at the workforce level, the country level, the state level, the city level, the department level, the team level, the worker level, etc. In one embodiment, trends over time (e.g., yearly, monthly, weekly, daily, etc.) in any metric may be provided as identified from the derived data points.

In step 230, the workforce activity data computer program may take an automated action based on one or more trend in the derived data points. In embodiments, the workforce activity data computer program may interface with calendaring programs, phone systems, messaging (e.g., email) systems, scheduling systems, access control systems, etc. For example, if the workforce activity data computer program identifies a trend that time above a certain threshold (e.g., more than x hours per day) is spent in meetings, then the workforce activity data computer program may automatically block of a team's calendars from meetings for a certain amount of time. If the workforce activity data computer program identifies a worker's range as being between 8 am and 6 pm, the workforce activity data computer program may prevent meetings from being scheduled, may route incoming calls to voicemail, etc. during times outside that range.

Embodiments may also recommend planned vacations for workers based on the enriched data.

Embodiments may further schedule workspaces for workers using the derived data.

Users, including workers, may provide feedback so that the workforce activity data program may modify actions it may take. For example, if the workforce activity data program blocks off certain time for in-person meetings, but that is providing a desirable result, the feedback received from the workers may reduce the amount of blocked-off time, or eliminate it altogether.

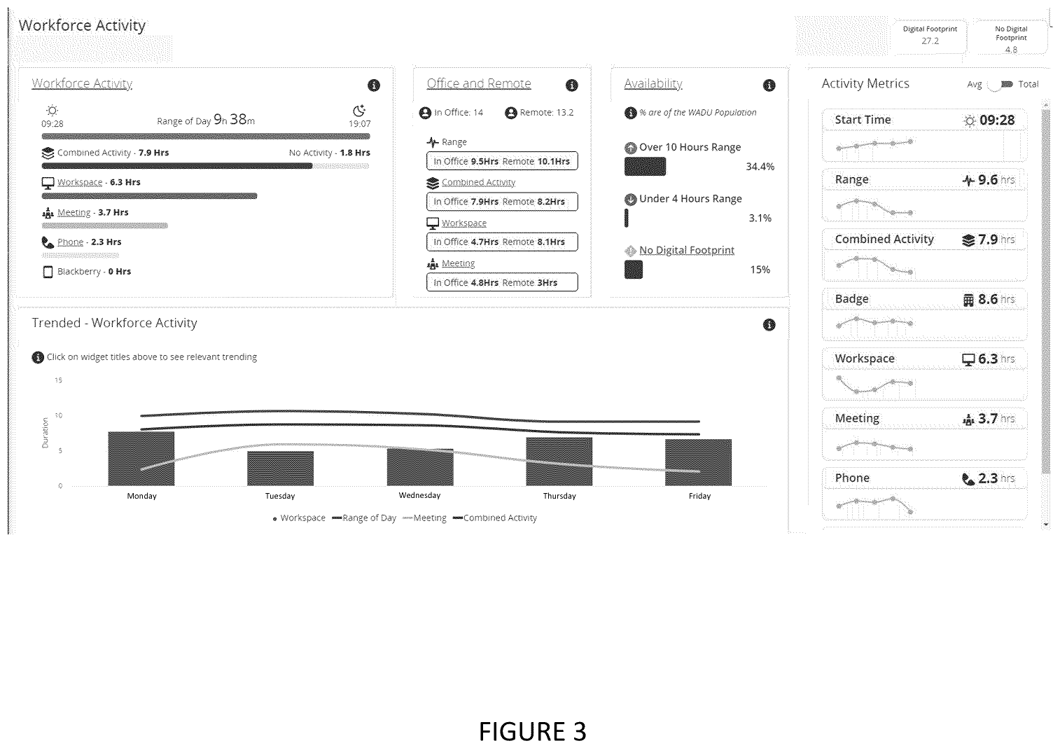

An example of a dashboard is provided in FIG. 3.

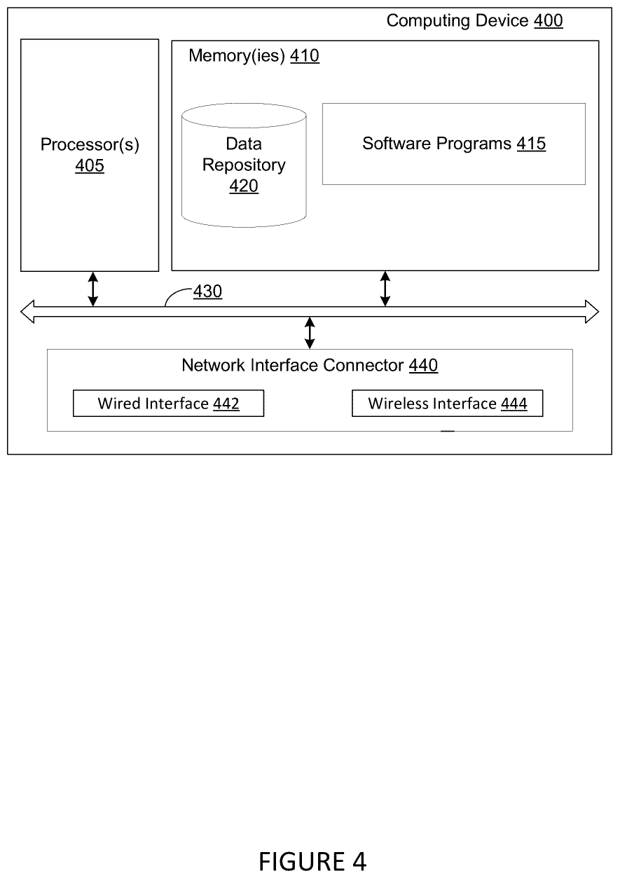

FIG. 4 depicts an exemplary computing system for implementing aspects of the present disclosure. FIG. 4 depicts exemplary computing device 400. Computing device 400 may represent the system components described herein, including, for example, backend 112. Computing device 400 may include processor 405 that may be coupled to memory 410. Memory 410 may include volatile memory. Processor 405 may execute computer-executable program code stored in memory 410, such as software programs 415. Software programs 415 may include one or more of the logical steps disclosed herein as a programmatic instruction, which may be executed by processor 405. Memory 410 may also include data repository 420, which may be nonvolatile memory for data persistence. Processor 405 and memory 410 may be coupled by bus 430. Bus 430 may also be coupled to one or more network interface connectors 440, such as wired network interface 442 or wireless network interface 444. Computing device 400 may also have user interface components, such as a screen for displaying graphical user interfaces and receiving input from the user, a mouse, a keyboard and/or other input/output components (not shown).

Although several embodiments have been disclosed, these embodiments are not exclusive to each other, and features from one may be used with others.

Hereinafter, general aspects of implementation of the systems and methods of the invention will be described.

The system of the invention or portions of the system of the invention may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of a compact disc, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for deriving workforce activity and behavioral insights from data exhaust, comprising:
ingesting, by a workforce activity data computer program executed by an electronic device, worker data for a plurality of workers from a plurality of data sources;
retrieving, by the workforce activity data computer program, reference data;
joining, by the workforce activity data computer program, the worker data and the reference data;
enriching, by the workforce activity data computer program, derived data points from the joined worker data and reference data; and
outputting, by the workforce activity data computer program, the enriched derived data points.

2. The method of claim 1, wherein the worker data comprises worker application usage data, worker facility access data, worker network access data, worker calendar data, and worker email data.

3. The method of claim 1, wherein the reference data comprises employee data and real estate data.

4. The method of claim 1, wherein the worker data and the reference data are joined using linked identifiers.

5. The method of claim 1, further comprising:
de-identifying, by the workforce activity data computer program, the worker data.

6. The method of claim 1, wherein the enriched derived data points comprise a range for one of the plurality of workers, a digital footprint for one of plurality of workers, a combined activity metric footprint for one of plurality of workers, a time spent in office metric for one of plurality of workers, a time spent remote for one of plurality of workers, a time spent in in-person meetings metric for one of plurality of workers, a time spent in virtual meetings metric for one of plurality of workers, a time spent on phone metric for one of plurality of workers, and/or a time spent in one-on-one meeting with managers or subordinates metric.

7. The method of claim 1, wherein the enriched derived data points are output at a worker level, a team level, an office level, and/or an organization level.

8. The method of claim 1, further comprising:
interfacing, by the workforce activity data computer program, with a calendaring program to limit meeting time for one of the plurality of workers based on one of the enriched derived data points.

9. The method of claim 1, further comprising:
interfacing, by the workforce activity data computer program, with a phone system to route incoming phone calls for one of the plurality of workers to voicemail based on one of the enriched derived data points.

10. The method of claim 1, further comprising:
interfacing, by the workforce activity data computer program, with a scheduling system to schedule a workspace for one of the plurality of workers based on one of the enriched derived data points.

11. A system, comprising:
a plurality of data sources for worker data; and
an electronic device executing a workforce activity data computer program;
wherein:
the workforce activity data computer program ingests worker data for a plurality of workers from a plurality of data sources;
the workforce activity data computer program receives reference data;
the workforce activity data computer program joins the worker data and the reference data;
the workforce activity data computer program enriches derived data points from the joined worker data and reference data; and
the workforce activity data computer program outputs the enriched derived data points.

12. The system of claim 11, wherein the worker data comprises worker application usage data, worker facility access data, worker network access data, worker calendar data, and worker email data.

13. The system of claim 11, wherein the reference data comprises employee data and real estate data.

14. The system of claim 11, wherein the worker data and the reference data are joined using linked identifiers.

15. The system of claim 11, wherein the workforce activity data computer program de-identifies the worker data.

16. The system of claim 11, wherein the enriched derived data points comprise a range for one of the plurality of workers, a digital footprint for one of plurality of workers, a combined activity metric footprint for one of plurality of workers, a time spent in office metric for one of plurality of workers, a time spent remote for one of plurality of workers, a time spent in in-person meetings metric for one of plurality of workers, a time spent in virtual meetings metric for one of plurality of workers, a time spent on phone metric for one of plurality of workers, and/or a time spent in one-on-one meeting with managers or subordinates metric.

17. The system of claim 11, wherein the enriched derived data points are output at a worker level, a team level, an office level, and/or an organization level.

18. The system of claim 11, wherein the workforce activity data computer program interfaces with a calendaring program to limit meeting time for one of the plurality of workers based on one of the enriched derived data points.

19. The system of claim 11, wherein the workforce activity data computer program interfaces with a phone system to route incoming phone calls for one of the plurality of workers to voicemail based on one of the enriched derived data points.

20. The system of claim 11, wherein the workforce activity data computer program interfaces with a scheduling system to schedule a workspace for one of the plurality of workers based on one of the enriched derived data points.
